(19) United States
(12) Patent Application Publication
(10) Pub. No.: US 2025/0219252 A1
(43) Pub. Date: Jul. 3, 2025

(54) POLYOLEFIN MICROPOROUS MEMBRANE, METHOD FOR MANUFACTURING THE MICROPOROUS MEMBRANE, AND SEPARATOR INCLUDING THE MICROPOROUS MEMBRANE

(71) Applicants: SK INNOVATION CO., LTD., Seoul (KR); SK IE TECHNOLOGY CO., LTD., Seoul (KR)

(72) Inventor: In Hwa JUNG, Daejeon (KR)

(21) Appl. No.: 19/002,689

(22) Filed: Dec. 27, 2024

(30) Foreign Application Priority Data
Dec. 27, 2023 (KR) 10-2023-0192688

(51) Int. Cl. H01M 50/489; B29C 48/00; B29C 48/08; B29C 48/91; B29K 23/00; B29K 105/00; B29K 105/04; B29L 31/00; B29L 31/34; H01M 10/052; H01M 50/406; H01M 50/417; H01M 50/491

(52) U.S. Cl. CPC H01M 50/489; B29C 48/0018; B29C 48/022; B29C 48/08; B29C 48/91; H01M 10/052; H01M 50/406; H01M 50/417; H01M 50/491; B29K 2023/06; B29K 2023/12; B29K 2105/0088; B29K 2105/0094; B29K 2105/041; B29K 2995/0012; B29K 2995/0053; B29K 2995/0065; B29K 2995/0088; B29K 2995/0097; B29L 2031/3468; B29L 2031/755

(57) ABSTRACT

A polyolefin microporous membrane, a method for manufacturing the same, and a separator including the microporous membrane are provided. The polyolefin microporous membrane including 60 wt % to 80 wt % of a polypropylene having a viscosity average molecular weight of 1×10⁶ g/mol to 3×10⁶ g/mol and 20 wt % to 40 wt % of a polyethylene having a weight average molecular weight of 1×10⁵ g/mol to 10×10⁵ g/mol is provided, wherein the polyolefin microporous membrane has a puncture strength of 0.25 N/μm or more, a gas permeability of 1.0×10⁻⁵ Darcy or more, a porosity of 30% to 70%, an average pore size of 20 nm to 40 nm, a shutdown temperature of 150° C. or lower, and a meltdown temperature of 180° C. or higher.

### CROSS-REFERENCE TO RELATED APPLICATIONS

This application claims priority under 35 U.S.C. § 119 to Korean Patent Application No. 10-2023-0192688, filed on Dec. 27, 2023, the disclosure of which is incorporated herein by reference in its entirety.

### TECHNICAL FIELD

Embodiments of the present disclosure relate to a polyolefin microporous membrane, a method for manufacturing the microporous membrane, and a separator including the microporous membrane.

### BACKGROUND

A polyolefin microporous membrane is used in various fields such as, for example, a separation filter, a separator for a secondary battery, a separator for a fuel cell, and a separator for a supercapacitor. Among them, it is widely used as a separator for a secondary battery, since it has excellent electrical insulation and ion permeability.

Recently, since a secondary battery has a higher capacity and is larger in size in order to be applied to an electric vehicle, an energy storage system (ESS), and the like, securing battery safety is a more important element. For example, when a battery is exposed to or operated in a high temperature environment, a separator may be shrunk which may cause an internal short circuit and a risk of fire due to the internal short circuit.

A current polyolefin microporous membrane for a secondary battery separator includes a shutdown function for securing battery safety. The shutdown function works by significantly increasing the resistance of the separator by melting a polyolefin to close the pores of the separator. In the event of a temperature rise due to a battery abnormality, the shutdown function increases the internal resistance of the battery preventing substantial current flow and thus, safety is secured.

When a battery is exposed to a higher temperature, the separator is ruptured (melt down) and a positive electrode and a negative electrode are internally short-circuited to greatly increase fire risk. In particular, since a secondary battery which has a higher capacity and has a larger size has a faster heating rate, there is a risk of meltdown before a shutdown function works properly.

Therefore, development of a polyolefin microporous membrane having excellent heat resistance is needed so that it may prevent a rapid temperature rise of a battery. In addition, high mechanical strength is required for improving safety in a battery manufacturing process and during use of the battery together with heat resistance, and also is required to have high permeability for improving a capacity and output.

### SUMMARY

An embodiment of the present disclosure is directed to providing a polyolefin microporous membrane having improved heat resistance at a high temperature, a method for manufacturing the microporous membrane, and a separator including the microporous membrane.

Another embodiment of the present disclosure is directed to providing a polyolefin microporous membrane having improved mechanical strength and permeability, a method for manufacturing the microporous membrane, and a separator including the microporous membrane.

The polyolefin microporous membrane and the separator of the present disclosure may be widely applied to green technology fields such as electric vehicles, battery charging stations, and other solar power generation and wind power generation using batteries. The polyolefin microporous membrane and the separator of the present disclosure may be used in eco-friendly electric vehicles, hybrid vehicles, and the like for preventing climate change by suppressing air pollution and greenhouse gas emission.

In an embodiment, a polyolefin microporous membrane includes: 60 wt % to 80 wt % of a polypropylene having a viscosity average molecular weight of 1×10⁶ g/mol to 3×10⁶ g/mol and 20 wt % to 40 wt % of a polyethylene having a weight average molecular weight of 1×10⁵ g/mol to 10×10⁵ g/mol, wherein the polyolefin microporous membrane has a puncture strength of 0.25 N/μm or more, a gas permeability of 1.0×10⁻⁵ Darcy or more, a porosity of 30% to 70%, an average pore size of 20 nm to 40 nm, a shutdown temperature of 150° C. or lower, and a meltdown temperature of 180° C. or higher. The polypropylene may be a homopolymer polypropylene. The polyethylene may be a homopolymer polyethylene.

In an embodiment, the polypropylene may have a melting temperature of 160° C. or higher.

In an embodiment, the polyethylene may have a melting temperature of 133° C. or higher.

In an embodiment, the microporous membrane may have a thickness of 3 μm to 30 μm.

In an embodiment, the shutdown temperature may be 149° C. or lower.

In an embodiment, the polyolefin microporous membrane may be manufactured by a wet method including a sequential biaxial stretching process.

In another embodiment, a method for manufacturing a polyolefin microporous membrane includes (a) melt kneading a mixture including a polyolefin resin and a diluent through an extruder to prepare a molten material; (b) extruding the molten material to be molded into a sheet form; (c) sequentially biaxially stretching the sheet in machine direction(MD) (longitudinal direction) and transverse direction(TD) to be molded into a film; (d) extracting the diluent from the stretched film and drying the film; and (e) heat treating the dried film. Herein, the polyolefin resin of operation (a) may include 60 wt % to 80 wt % of the polypropylene having the viscosity average molecular weight of 1×10⁶ g/mol to 3×10⁶ g/mol and 20 wt % to 40 wt % of the polyethylene having a weight average molecular weight of 1×10⁵ g/mol to 10×10⁵ g/mol.

In an embodiment, operation (d) may include extracting the diluent from the stretched film and drying the film with shrinkages of 5% or less in the machine direction and 10% or less in the transverse direction.

In an embodiment, operation (e) may include heat treating the dried film in a temperature range between a melting temperature of the polyethylene (Tm) and a temperature higher than the melting temperature by 8° C. (Tm+8° C.).

In still another embodiment, a separator includes the polyolefin microporous membrane described above.

In yet another embodiment, a secondary battery such as a lithium secondary battery is provided which includes the inventive separator.

Other features and aspects will be apparent from the following detailed description and the claims.

### DETAILED DESCRIPTION

The embodiments described in the present specification may be modified in many different forms, and the technology according to any of the embodiments is not limited to the embodiments set forth herein. In addition, the embodiment is provided so that the present disclosure will be further fully described to a person with ordinary skill in the art.

In addition, the singular form used in the specification and claims appended thereto may be intended to include a plural form also, unless otherwise indicated in the context.

In addition, the numerical range used in the present specification includes all values within the range including the lower limit and the upper limit, increments logically derived in a form and span of a defined range, all double limited values, and all possible combinations of the upper limit and the lower limit in the numerical range defined in different forms. Unless otherwise defined in the present specification, values which may be outside a numerical range due to experimental error or rounding off of a value are also included in the defined numerical range.

Furthermore, throughout the specification, unless explicitly described to the contrary, “comprising” any constituent elements will be understood to imply further inclusion of other constituent elements rather than exclusion of other constituent elements.

In an embodiment, a polyolefin microporous membrane includes 60 wt % to 80 wt % of a polypropylene having a viscosity average molecular weight of 1×10⁶ g/mol to 3×10⁶ g/mol and 20 wt % to 40 wt % of a polyethylene having a weight average molecular weight of 1×10⁵ g/mol to 10×10⁵ g/mol, wherein the polyolefin microporous membrane has a puncture strength of 0.25 N/μm or more, a gas permeability of 1.0×10⁻⁵ Darcy or more, a porosity of 30% to 70%, an average pore size of 20 nm to 40 nm, a shutdown temperature of 150° C. or lower, and a meltdown temperature of 180° C. or higher.

Recently, as a secondary battery has higher capacity and gets larger, it is required that better battery performance and safety are met, and to this end, it is required that a separator for a secondary battery has higher levels of heat resistance and permeability simultaneously.

To this end, a polypropylene having a high melting temperature is used as a material of a separator for a secondary battery, but the polypropylene microporous membrane manufactured by a dry process is inappropriate for being used in a secondary battery field due to its low puncture strength and excessively large and non-uniform pore size.

As a result of repeated research by the inventors, it was confirmed that a polyolefin microporous membrane having significantly improved heat resistance at a high temperature while having excellent puncture strength and permeability may be manufactured by implementing the puncture strength, the gas permeability, the porosity, the average pore size, the shutdown temperature, and the meltdown temperature in the ranges described above simultaneously.

A secondary battery according to an embodiment may secure both excellent battery performance and safety, by including the polyolefin microporous membrane satisfying the physical properties as described above simultaneously. In particular, the present disclosure may provide a secondary battery including a microporous membrane which has closed pores at a temperature of 150° C. or lower and may maintain a separator form even at a temperature of 180° C. or higher.

That is, since the polyolefin microporous membrane of the present disclosure satisfies the physical properties as described above simultaneously, the microporous membrane is appropriate for being applied to a high-output/high-capacity battery.

The polyolefin microporous membrane may be manufactured by a wet method including a sequential biaxial stretching process unless it goes beyond the scope of the present disclosure.

According to an embodiment, the polyolefin microporous membrane which satisfies the physical properties as described above simultaneously may be manufactured by including a specific polyethylene resin and a specific polypropylene resin at a specific composition ratio. For example, the microporous membrane according to an embodiment may include 60 wt % to 80 wt % of the polypropylene having the viscosity average molecular weight of 1×10⁶ g/mol to 3×10⁶ g/mol and 20 wt % to 40 wt % of the polyethylene having a weight average molecular weight of 1×10⁵ g/mol to 10×10⁵ g/mol. In addition, in an embodiment, the polypropylene may have a melting temperature of 160° C. or higher, 162° C. or higher and 170° C. or lower, 165° C. or lower, or a value between the above numerical values. For example, the polypropylene may have a melting temperature of 160° C. to 170° C. or 162° C. to 165° C. In addition, in an embodiment, the polyethylene may have a melting temperature of 133° C. or higher, 133° C. to 140° C., or 133° C. to 135° C.

According to an embodiment, the polyolefin microporous membrane may be manufactured by including the raw material resins used at a specific composition ratio and performing extraction/drying processes under specific conditions. For example, the polyolefin microporous membrane may be manufactured by extruding and sequentially biaxially stretching a mixture of a diluent dissolved in a polyolefin resin including a polyethylene resin and a polypropylene resin at a specific composition ratio to manufacture a film form, extracting the diluent from the film, and drying the film at a specific shrinkage rate. For example, the diluent may be extracted from the stretched film and the film may be dried with shrinkages of 5% or less in a machine direction and 10% or less in a transverse direction. Accordingly, since the polyolefin microporous membrane satisfies all physical properties described above, it has excellent mechanical strength and permeability and also has significantly improved heat resistance at a high temperature.

According to an embodiment, the polyolefin microporous membrane may be manufactured by using the raw material resins at a specific composition ratio and performing a heat treatment process at a specific temperature. For example, the heat treatment process of the mixed polyolefin microporous membrane of the polypropylene and the polyethylene may be carried out within a temperature range between a melting temperature of polyethylene (Tm) and a temperature higher than the melting temperature by 8° C. (Tm+8° C.) among the components.

By combining the above conditions with each other, the polyolefin microporous membrane of the present disclosure satisfies all physical properties described above, and thus, has excellent mechanical strength and permeability and also has significantly improved heat resistance at a high temperature. That is, an embodiment of the present disclosure may provide a polyolefin microporous membrane having a puncture strength of 0.25 N/μm or more, a gas permeability of 1.0×10⁻⁵ Darcy or more, a porosity of 30% to 70%, an average pore size of 20 nm to 40 nm, a shutdown temperature of 150° C. or lower, and a meltdown temperature of 180° C. or higher.

Hereinafter, the polyolefin microporous membrane will be described in more detail.

In an embodiment, the polypropylene included in the polyolefin microporous membrane may have a viscosity average molecular weight of 1×10⁶ g/mol or more, 1.2×10⁶ g/mol or more, 1.3×10⁶ g/mol or more and 3×10⁶ g/mol or less, 2.5×10⁶ g/mol or less, 2.2×10⁶ g/mol or less, 1.8×10⁶ g/mol or less, or a value between the above numerical values. For example, the viscosity average molecular weight of the polypropylene may be 1×10⁶ g/mol to 3×10⁶ g/mol, 1.2×10⁶ g/mol to 2.5×10⁶ g/mol, 1.3×10⁶ g/mol to 2.2×10⁶ g/mol, or 1.3×10⁶ g/mol to 1.8×10⁶ g/mol.

In an embodiment, a content of the polypropylene included in the polyolefin microporous membrane may be 60 wt % or more, 65 wt % or more, 70 wt % or more and 80 wt % or less, 75 wt % or less, or a value between the above numerical values, based on the total amount of the polyethylene and the polypropylene. For example, the content of the polypropylene may be 60 wt % to 80 wt %, 65 wt % to 75 wt %, or 70 wt % to 75 wt %. According to an embodiment, when the content of the polypropylene satisfies the above ranges it may have the shutdown temperature of 150° C. or lower and the meltdown temperature of 180° C. or higher while having excellent puncture strength and gas permeability.

In an embodiment, the polypropylene may have a melting temperature of 160° C. or higher, 162° C. or higher and 170° C. or lower, 165° C. or lower, or a value between the above numerical values. For example, the polypropylene may have the melting temperature of 160° C. to 170° C. or 162° C. to 165° C. According to an embodiment, when the melting temperature of the polypropylene satisfies the above ranges it may have the shutdown temperature of 150° C. or lower and the meltdown temperature of 180° C. or higher while having excellent puncture strength and gas permeability.

In an embodiment, the polyethylene included in the polyolefin microporous membrane may have a weight average molecular weight of 1×10⁵ g/mol or more, 3×10⁵ g/mol or more and 10×10⁵ g/mol or less, 9×10⁵ g/mol or less, or a value between the above numerical values. For example, the weight average molecular weight of the polyethylene may be 1×10⁵ g/mol to 10×10⁵ g/mol, 3×10⁵ g/mol to 10×10⁵ g/mol, or 3×10⁵ g/mol to 9×10⁵ g/mol.

In an embodiment, a content of the polyethylene included in the polyolefin microporous membrane may be or more, 20 wt % or more, 25 wt % or more and 40 wt % or less, 35 wt % or less, or a value between the above numerical values, based on the total amount of the polypropylene and the polyethylene. For example, the content of the polyethylene may be 20 wt % to 40 wt % or 25 wt % to 35 wt %. According to an embodiment, when the content of the polyethylene satisfies the above ranges the polyolefin microporous membrane may have the shutdown temperature of 150° C. or lower and the meltdown temperature of 180° C. or higher while having excellent puncture strength and gas permeability.

In an embodiment, the polyethylene may have a melting temperature of 133° C. or higher, 133° C. to 140° C., or 133° C. to 135° C. According to an embodiment, when the melting temperature of the polyethylene satisfies the above ranges the polyolefin microporous membrane may have the shutdown temperature of 150° C. or lower and the meltdown temperature of 180° C. or higher while having excellent puncture strength and gas permeability.

In an embodiment, the polyolefin microporous membrane may have a puncture strength of 0.25 N/μm or more, 0.30 N/μm or more and 1.0 N/μm or less, 0.8 N/μm or less, 0.5 N/μm or less, or a value between the above numerical values. For example, the puncture strength may be 0.25 N/μm to 1.0 N/μm, 0.30 N/μm to 0.8 N/μm, or 0.30 N/μm to 0.5 N/μm. Since the puncture strength in the range described above is satisfied, the battery exhibits excellent resistance to external stress during manufacturing, as well as to dendrite formation during charge and discharge cycles. Consequently, this ensures the safety of the battery.

In an embodiment, the polyolefin microporous membrane may have a gas permeability of 1.0×10⁻⁵ Darcy or more, 1.15×10⁻⁵ Darcy or more and 5.0×10⁻⁵ Darcy or less, 3.0×10-5 Darcy or less, or a value between the above numerical values. For example, gas permeability may be 1.0×10⁻⁵ Darcy to 5.0×10⁻⁵ Darcy or 1.15×10⁻⁵ Darcy to 3.0×10⁻⁵ Darcy. Since the specified gas permeability range is achieved, ion conductivity may be excellent. As a result, the battery's charge and discharge characteristics may be improved due to reduced battery internal resistance.

In an embodiment, the polyolefin microporous membrane may have a porosity of 30% or more, 35% or more, 37% or more and 70% or less, 60% or less, 50% or less, or a value between the above numerical values. For example, the porosity may be 30% to 70%, 35% to 60%, or 37% to 50%.

In an embodiment, the polyolefin microporous membrane may have an average pore size of 20 nm or more, 24 nm or more and 40 nm or less, 35 nm or less, or a value between the above numerical values. For example, the average pore size may be 20 nm to 40 nm or 24 nm to 35 nm.

In an embodiment, the polyolefin microporous membrane may have a shutdown temperature of 150° C. or lower, 149,5° C. or lower, 140° C. to 150° C., 145° C. to 149.5° C., 145° C. to 149° C., or 145° C. to 148.5° C. Since the shutdown temperature in the range described above is satisfied, excellent safety may be secured even when a temperature rise occurs due to the occurrence of battery abnormality.

In an embodiment, the polyolefin microporous membrane may have a meltdown temperature of 180° C. or higher or 180° C. to 190° C. Since the meltdown temperature in the range described above is satisfied, an internal short circuit due to the rupture of the microporous membrane may be suppressed even when the temperature of a battery to which the polyolefin microporous membrane is applied rapidly rises, so that excellent safety may be secured.

In an embodiment, the polyolefin microporous membrane may have a thickness of 3 μm or more, 5 μm or more and 30 μm or less, 20 μm or less, 15 μm or less, or a value between the above numerical values. For example, the thickness of the microporous membrane may be 3 μm to 30 μm, 3 μm to 20 μm, or 5 μm to 15 μm. The microporous membrane of the present disclosure may implement excellent puncture strength, gas permeability, porosity, average pore size, and heat resistance simultaneously even at the thickness in the range described above, and, in particular, may have the shutdown temperature of 150° C. or lower and the meltdown temperature of 180° C. or higher. According to an embodiment, the separator for a secondary battery may be made to be thinner and is suitable for use in high capacity/high output batteries.

In an embodiment, the polyolefin microporous membrane may be manufactured by a wet method including a sequential biaxial stretching process, and thus, a polyolefin microporous membrane satisfying the physical properties as described above simultaneously may be provided. Accordingly, since the polyolefin microporous membrane satisfies all of the aforementioned physical properties, it exhibits excellent mechanical strength and permeability, as well as significantly improved heat resistance at high temperatures.

Specifically, the polyolefin microporous membrane is manufactured by dissolving a diluent into a polyolefin resin, which includes a polyethylene resin and a polypropylene resin in a certain composition ratio, extruding and sequentially biaxially stretching the resulting mixture into a film, and subsequently extracting the diluent from the film. It can be produced using a wet process that involves a conventional sequential biaxial stretching process known to those skilled in the art, and it is not limited as long as it can produce a microporous membrane possessing the aforementioned physical properties.

According to an embodiment, the diluent can be extracted from the sequentially biaxially stretched film. The film may then be dried with shrinkages of 5% or less in the machine direction and 10% or less in the transverse direction. However, other suitable methods may be used as long as they remain within the scope of this disclosure.

According to an embodiment, the dried film obtained by an extraction/drying process may be heat treated in a temperature range between a melting temperature of the polyethylene (Tm) and a temperature higher than the melting temperature by 8° C. (Tm+8° C.), but it may be performed by another way unless it goes beyond the scope of the present disclosure.

Hereinafter, the method for manufacturing a polyolefin microporous membrane of the present disclosure will be described.

The method for manufacturing a polyolefin microporous membrane according to an embodiment includes (a) melt kneading a mixture including a polyolefin resin and a diluent through an extruder to prepare a molten material; (b) extruding the molten material to be molded into a sheet form; (c) sequentially biaxially stretching the sheet in machine and transverse directions to be molded into a film; (d) extracting the diluent from the stretched film and drying the film; and (e) heat treating the dried film, and the polyolefin resin of operation (a) may include 60 wt % to 80 wt % of a polypropylene having a viscosity average molecular weight of 1×10⁶ g/mol to 3×10⁶ g/mol and 20 wt % to 40 wt % of a polyethylene having a weight average molecular weight of 1×10⁵ g/mol to 10×10⁵ g/mol, wherein the method of blending the polypropylene and polyethylene is not particularly limited, they can be pre-mixed and then fed into an extruder, or each material can be fed separately into the extruder and kneaded within the extruder.

Hereinafter, each operation of the manufacturing method is described.

First, operation(a) is an operation of melting and kneading a mixture including a polyolefin resin and a diluent through an extruder to prepare a molten material, and the mixture may include the polyolefin resin and the diluent at a weight ratio of 10-60:90-40 or at a weight ratio of 20-40:80-60, for forming pores, but is not particularly limited thereto unless it goes beyond the scope of the present disclosure.

In operation (a), the polyolefin resin may include 60 wt % to 80 wt % of the polypropylene having the viscosity average molecular weight of 1×10⁶ g/mol to 3×10⁶ g/mol and 20 wt % to 40 wt % of the polyethylene having a weight average molecular weight of 1×10⁵ g/mol to 10×10⁵ g/mol. For example, 65 wt % to 75 wt % of the polypropylene and 25 wt % to 35 wt % of the polyethylene may be included. According to an embodiment, when the polyolefin resin satisfies the above composition, a polyolefin microporous membrane having a puncture strength of 0.25 N/p or more, a gas permeability of 1.0×10⁻⁵ Darcy or more, a porosity of 30% to 70%, an average pore size of 20 nm to 40 nm, a shutdown temperature of 150° C. or lower, and a meltdown temperature of 180° C. or higher may be manufactured. A secondary battery including the microporous membrane satisfying all physical properties may exhibit both excellent battery performance and safety.

Since the viscosity average molecular weight (or weight average molecular weight) and the melting temperature of the polypropylene and the polyethylene are as described above, a detailed description thereof will be omitted.

In an embodiment, the diluent may be any suitable diluent without limitation provided it is an organic compound forming a single phase with the polyolefin resin at an extrusion temperature. For example, the diluent may be at least one selected from the group consisting of aliphatic or cyclic hydrocarbons such as nonane, decane, decalin, paraffin oil, and paraffin wax, phthalic acid esters such as dibutyl phthalate and dioctyl phthalate, C10-C20 fatty acids such as palmitic acid, stearic acid, oleic acid, linoleic acid, and linolenic acid, and C10-C20 fatty alcohols such as cetyl alcohol (also known as palmityl alcohol), stearyl alcohol, and oleyl alcohol. According to a specific embodiment the diluent may include a paraffin oil having a kinetic viscosity at 40° C. of 20 cSt to 200 cSt. However, instead of paraffin any of the other diluents may be used.

In addition, the mixture may further include one or more of general additives for improving specific functions such as an oxidation stabilizer, a UV stabilizer, and an antistatic agent in a range where the characteristics of the microporous membrane are not greatly deteriorated.

Next, according to operation (b) extruding the molten material is performed to mold a sheet form. The extruding may be performed without limitation by any suitable method known to a person skilled in the art. For example, the molten material may be extruded through a T-die and may be molded into a sheet form by a casting or calendering method while cooling to a temperature of 10° C. to 80° C. However, any other suitable method may also be used provided it does not go beyond the scope of the present disclosure.

Next, according to operation (c) the sheet is sequentially biaxially stretched in machine and transverse directions to mold a film, and the longitudinal and transverse stretching ratios may be independently of each other 4 times or more, 6 times or more, 10 times or more and times or less, or a value between the above numerical values. For example, the longitudinal and transverse stretching ratios may be 4 times to 15 times or 6 times to times its original size. Since the longitudinal and transverse stretching ratios satisfy the ranges described above, the polyolefin microporous membrane having the physical properties as described above simultaneously may be manufactured.

The stretching in operation (c) may be performed by a sequential stretching method in a roll or tenter manner, and performed at a temperature in a range between a temperature lower than the melting temperature of polypropylene by 80° C. and the melting temperature of polypropylene. When stretching is conducted within the specified temperature range, the polypropylene resin maintains its flowability, enabling effective stretching. This ensures uniform stretching across the sheet, preventing fractures. Consequently, stretching occurs stably, allowing the production of a high-quality microporous membrane with consistent physical properties, such as uniform gas permeability and puncture strength, throughout the membrane. For example, the stretching may be performed at 100° C. to 170° C. or 110° C. to 160° C., but is not limited thereto.

Next, operation (d) is an operation of extracting the diluent from the stretched film and drying the film, and is performed by extracting the diluent inside the film using an organic solvent and drying the organic solvent in the film in which the diluent is replaced with the organic solvent. The organic solvent may be used without particular limitation as long as the diluent may be extracted. For example, methyl ethyl ketone, methylene chloride, hexane, and the like may be used in terms of high extraction efficiency and rapid drying with the organic solvent, but other methods may be performed unless it goes beyond the scope of the present disclosure.

In an embodiment, operation (d) may include extracting the diluent from the stretched film and drying the film with shrinkages of 5% or less in the machine direction and 10% or less in the transverse direction. When the diluent is extracted from the film manufactured of the polyolefin resin satisfying the composition described above and the film is shrunk and dried under the conditions described above, a microporous membrane satisfying the puncture strength, the gas permeability, the porosity, the average pore size, the shutdown temperature, and the meltdown temperature as described above simultaneously may be provided. A secondary battery including the microporous membrane as such may secure both excellent battery performance and safety.

According to an embodiment, the longitudinal shrinkage rate (shrinkage rate in MD) during the extraction/drying process may be 5% or less, 4% or less, or 3.5% or less and 1% or more, and for example, 1% to 5%, 1% to 4%, or 1% to 3.5%. The transverse shrinkage rate(shrinkage rate in TD) during the extraction/drying process may be 10% or less, 9% or less, 8.5% or less and 1% or more, and for example, may be 1% to 10%, 1% to 9%, or 1% to 8.5%. The longitudinal (or transverse) shrinkage rate may be calculated by the following Equation 1:

$$Longitudinal ( or transverse ) shrinkage rate ( \% ) = [ \{ longitudunal ( or transverse ) length before extraction - longitudinal ( or transverse ) length after drying \} / longitudunal ( or transverse ) length before extraction ] \times 100 \qquad Equation 1$$

The longitudinal or transverse shrinkage during the extraction/drying process may be adjusted by the tension applied to the film in the drying process. When the tension is high, small shrinkage occurs, and when the tension is low, big shrinkage occurs. The tension applied to the film in the drying process may be determined differently depending on the thickness of the film, but the size may be appropriately changed unless it goes beyond the scope of the present disclosure.

According to an embodiment, operation (d) may be performed at a temperature of 40° C. or lower, but may be performed at other temperatures unless it goes beyond the scope of the present disclosure.

Operation (e) is an operation of heat treating the dried film. The heat resistance of the final polyolefin microporous membrane can be enhanced by applying heat to remove residual stress while the film is held under tension. This ensures no dimensional changes occur in the machine and transverse directions, using a roll or tenter device.

In an embodiment, the operation (e) may include heat treating the dried film in a temperature range between a melting temperature of the polyethylene (Tm) and a temperature higher than the melting temperature by 8° C. (Tm+8° C.). When the film manufactured of the polyolefin resin satisfying the composition described above is heat treated at the temperature under the conditions described above, a microporous membrane satisfying the puncture strength, the gas permeability, the porosity, the average pore size, the shutdown temperature, and the meltdown temperature as described above simultaneously may be provided. A secondary battery including the microporous membrane as such may secure both excellent battery performance and safety.

In an embodiment, the heat treatment in operation (e) may be performed at a temperature in a range of 133° C. to 148° C., 133° C. to 145° C., or 134° C. to 142° C. Since the heat treatment is performed at the temperature in the range described above, a polyolefin microporous membrane satisfying all physical properties as described above may be manufactured.

In an embodiment, the heat treatment in operation (e) may be heat fixation by heat stretching and/or heat mitigation. That is, the heat treatment may be performed in various ways by adjusting tension during the heat treatment. The heat treatment may be repeated 1 to 3 times, however, the heat treatment may not necessarily be limited this way.

Operation(e) may include, for example, a heat stretching process of stretching in the machine or transverse directions, a heat fixation process of applying heat while fixing longitudinal and transverse length/width, and a heat mitigation process of mitigating (shrinking) in the machine or transverse directions. For example, the heat mitigation process may include mitigating to 80% to 99% or 90% to 99% of the transverse width before the heat mitigation process, and the heat stretching process may include stretching to 120% to 160% or 140% to 160% of the transverse width before the heat stretching process. However, these operations may also be performed by any other suitable way unless they go beyond the scope of the present disclosure.

The present disclosure provides a separator including the polyolefin microporous membrane as described above. The separator may be a separator used in any known energy storage device and is not particularly limited. In a non-limiting embodiment, the separator may include a separator used in a lithium secondary battery.

The embodiments of the present disclosure may provide a lithium secondary battery employing a separator disposed between an anode electrode and a cathode electrode, the separator comprising a polyolefin microporous membrane comprising: 60 wt % to 80 wt % of a polypropylene having a viscosity average molecular weight of 1×10⁶ g/mol to 3×10⁶ g/mol and 20 wt % to 40 wt % of a polyethylene having a weight average molecular weight of 1×10⁵ g/mol to 10×10⁵ g/mol.

Hereinafter, the embodiments of the present disclosure will be further described with reference to the specific experimental examples. It is apparent to those skilled in the art that the examples and the comparative examples included in the experimental examples only illustrate the embodiments of the present disclosure and do not limit the appended claims, and various modifications and alterations of the embodiments may be made within the scope and according the technical concepts of the present disclosure, and these modifications and alterations will fall within the appended claims.

### Method for Measuring Physical Properties

1. Viscosity Average Molecular Weight (g/Mol)

The viscosity average molecular weight was determined by measuring an intrinsic viscosity (η) using a Crystex QC model available from Polymer Char and performing calculation from a Margolies-equation represented by the following Equation 2. The intrinsic viscosity was measured at 165° C. using 1,2,4-trichlorobenzene (TCB) as a solvent.

$$Mv = 5.37 \times {10}^{4} \times {[ η ]}^{1.49} \qquad Equation 2$$

2. Weight Average Molecular Weight (g/Mol)

The weight average molecular weight (Mw) was measured using high temperature gel permeation chromatography (GPC) available from Agilent Technologies. PLgel Guard and PLgel Olexis were used as a GPC column, 1,2,4-trichlorobenzene (TCB) was used as a solvent, polystyrene was used as a standard sample, and analysis was performed at 140° C.

### 3. Melting Temperature (° C.)

The melting temperature was determined by a peak position in a curve measured by a differential scanning calorimeter (DSC). A temperature range from 25° C. to 200° C. was scanned at a heating rate of 10° C./min under a nitrogen atmosphere, using a Thermal Analysis System DSC 3+ model which is a differential scanning calorimeter (DSC) available from Mettler Toledo. The amount of the measurement sample at this time was 5 mg.

### 4. Thickness of Microporous Membrane (μm)

The thickness of the microporous membrane was measured using a contact type thickness meter having a thickness precision of 0.1 μm. The measurement was performed at a measurement pressure of 0.63 N using TESA Mu-Hite Electronic Height Gauge available from TESA.

### 5. Puncture Strength (N/μm)

The puncture strength was measured by attaching a pin tip having a diameter of 1.0 mm and a radius of curvature of 0.5 mm to Universal Test Machine (UTM) 3345 available from INSTRON and pressing a microporous membrane at a speed of 120 mm/min. At this time, a load (N) when the microporous membrane was broken was divided by a thickness (μm) of the microporous membrane to calculate the puncture strength.

### 6. Gas Permeability (Darcy)

The gas permeability was measured using a porometer (CFP-1500-AEL available from PMI). Generally, the gas permeability is expressed in a Gurley number, but since the Gurley number is not corrected for the effect of the thickness, it is difficult to know relative permeability depending on a pore structure. In order to solve the problem, the gas permeability of the present disclosure was measured using a Darcy permeability coefficient calculated from the following Mathematical Formula 3. Nitrogen was used as gas, and an average value of the Darcy permeability coefficients measured in a range of 100 to 200 psi was calculated.

$$Darcy permeability coefficient ( C ) = ( 8 F \cdot T \cdot V ) / ( π {D}^{2} ( {P}^{2} - 1 ) ) , \qquad Equation 3$$

Wherein F=flow velocity
T=sample thickness
V=gas viscosity (0.185 for N₂)
D=sample diameter
P=pressure

### 7. Porosity (%)

The porosity of the microporous membrane was calculated by the following equation 4. Specifically, a sample having a width of A cm, a length of B cm, and a thickness of T cm was prepared, its mass was measured, and the porosity was calculated from a ratio between a mass of a resin having the same volume and a mass of a microporous membrane.

$$Porosity ( \% ) = 100 \times \{ 1 - M / ( A \times B \times T \times ρ ) \} , \qquad Mathematical Formula 4$$

wherein M is a mass (g) of a microporous membrane, and ρ is a density (g/cm³) of a polyolefin resin forming a microporous membrane.

### 8. Average Pore Size (Nm)

The average pore size was measured from a porometer (CFP-1500-AEL available from PMI) in accordance with ASTM F316-03. The average pore size was measured by a half dry method, and a Galwick solution (surface tension: 15.9 dyne/cm) provided for measuring a pore size by PMI was used.

### 9. Shutdown Temperature and Meltdown Temperature

The shutdown temperature and the meltdown temperature of the microporous membrane were measured, using a self-manufactured cell for measuring electrical resistance. The cell for measuring electrical resistance was manufactured by the following method: A microporous membrane prepared in a 2.5 cm×2.5 cm size was placed between two glass cells, and then tightly fixed with a clip so that the binding site of the glass cell did not move. Next, an electrolyte solution in which 1 M hexafluorophosphate (LiPF₆) was dissolved in a propylene carbonate (PC) solvent was injected carefully to each glass cell so that bubbles were not produced. An aluminum electrode was placed in each glass cell to manufacture the final cell for measuring electrical resistance. The manufactured cell for measuring electrical resistance was placed in an oil bath preheated to 120° C., and the two electrodes were connected to an impedance analyzer (ZIVE SP2 available from ZIVE Lab). The resistance value of the cell was measured using an alternating current of 1 kHz (5 mV), while the oil bath temperature was heated to a heating rate of 2° C./min. The cell resistance value was plotted to the temperature, thereby measuring the shutdown temperature and the meltdown temperature. The shutdown temperature was set as a temperature at which the resistance value was 1000Ω or more, and the meltdown temperature was set as a temperature at which the resistance value was back to 1000Ω or less after the shutdown temperature.

### Example 1

A polyolefin resin including 25 wt % of a polyethylene resin having a weight average molecular weight of 6.0×10⁵ g/mol and a melting temperature of 134° C. and 75 wt % of a polypropylene resin having a viscosity average molecular weight of 1.5×10⁶ g/mol and a melting temperature of 164° C. was prepared. Next, a mixture including the polyolefin resin and a paraffin oil having a kinematic viscosity at 40° C. of 80 cSt at a weight ratio of 30:70 was melted and kneaded using a biaxial extruder to prepare a molten material.

The molten material was continuously extruded through a T-die and a casting roll set to 30° C. was used to manufacture a sheet having a width of 300 mm and an average thickness of 1200 μm.

The sheet was longitudinally stretched in a roll manner to be 6 times its original size at a stretching temperature of 115° C., and continuously transversely stretched to 6 times its original size at a stretching temperature of 140° C. by guidance with a tenter.

The paraffin oil was extracted from the film which completed stretching in the machine and transverse directions, using methylene chloride at 25° C. The film from which the paraffin oil had been extracted was dried at 60° C. while adjusting tension in an opposite direction to shrinkage stress occurring in the drying process after extraction so that the film was shrunk by 2% in the machine direction and 6% in the transverse direction as compared with the film before extraction.

The film after drying was fixed with heat at 140° C. for about 20 seconds using a tenter type heat fixation device to manufacture a polyolefin microporous membrane having a thickness of 10.5 μm. The physical properties of the finally manufactured microporous membrane are listed in the following Table 1.

### Example 2

A polyolefin microporous membrane was manufactured in the same manner as in Example 1, except that a polyolefin resin including 20 wt % of the polyethylene resin and 80 wt % of the polypropylene resin was used instead of the polyolefin resin of Example 1, and the results are listed in Table 1.

### Example 3

A polyolefin microporous membrane was manufactured in the same manner as in Example 1, except that a polyolefin resin including 40 wt % of the polyethylene resin and 60 wt % of the polypropylene resin was used instead of the polyolefin resin of Example 1, and the results are listed in Table 1.

### Example 4

A polyolefin microporous membrane was manufactured in the same manner as in Example 1, except that a polyethylene resin having a weight average molecular weight of 3.0×10⁵ g/mol and a melting temperature of 134° C. was used instead of the polyethylene resin of Example 1, and the results are listed in Table 1.

### Example 5

A polyolefin microporous membrane was manufactured in the same manner as in Example 1, except that a polyethylene resin having a weight average molecular weight of 10×10⁵ g/mol and a melting temperature of 134° C. was used instead of the polyethylene resin of Example 1 and a polypropylene resin having a viscosity average molecular weight of 2.0×10⁶ g/mol and a melting temperature of 164° C. was used instead of the polypropylene resin of Example 1, and the results are listed in Table 1.

### Example 6

A polyolefin microporous membrane was manufactured in the same manner as in Example 1, except that the film from which a paraffin oil had been extracted was dried to be shrunk by 3% in the machine direction and 8% in the transverse direction as compared with the film before extraction, and the results are listed in Table 1.

### Example 7

A polyolefin microporous membrane was manufactured in the same manner as in Example 1, except that the film from which a paraffin oil had been extracted was dried to be shrunk by 5% in the machine direction and 10% in the transverse direction as compared with the film before extraction, and the results are listed in Table 1.

### Example 8

A polyolefin microporous membrane was manufactured in the same manner as in Example 1, except that the heat fixation temperature was 142° C., and the results are listed in Table 1.

### Example 9

A polyolefin microporous membrane was manufactured in the same manner as in Example 1, except that the heat fixation temperature was 136° C., and the results are listed in Table 1.

### Comparative Example 1

A polyolefin microporous membrane was manufactured in the same manner as in Example 1, except that a polyolefin resin including 10 wt % of the polyethylene resin and 90 wt % of the polypropylene resin was used instead of the polyolefin resin of Example 1, and the results are listed in Table 2.

### Comparative Example 2

A polyolefin microporous membrane was manufactured in the same manner as in Example 1, except that a polyolefin resin including 18 wt % of the polyethylene resin and 82 wt % of the polypropylene resin was used instead of the polyolefin resin of Example 1, and the results are listed in Table 2.

### Comparative Example 3

A polyolefin microporous membrane was manufactured in the same manner as in Example 1, except that a polyolefin resin including 45 wt % of the polyethylene resin and 55 wt % of the polypropylene resin was used instead of the polyolefin resin of Example 1, and the results are listed in Table 2.

### Comparative Example 4

A polyolefin microporous membrane was manufactured in the same manner as in Example 1, except that a polyethylene resin having a weight average molecular weight of 1.1×10⁶ g/mol and a melting temperature of 134° C. was used instead of the polyethylene resin of Example 1 and the film from which a paraffin oil had been extracted was dried to be shrunk by 4% in the machine direction and 9% in the transverse direction as compared with the film before extraction, and the results are listed in Table 2.

### Comparative Example 5

A polyolefin microporous membrane was manufactured in the same manner as in Example 1, except that a polyethylene resin having a weight average molecular weight of 6.0×10⁵ g/mol and a melting temperature of 132° C. was used instead of the polyethylene resin of Example 1 and the heat fixation temperature was 138° C., and the results are listed in Table 2.

### Comparative Example 6

A polyolefin microporous membrane was manufactured in the same manner as in Example 1, except that a polypropylene resin having a viscosity average molecular weight of 1.5×10⁶ g/mol and a melting temperature of 158° C. was used instead of the polypropylene resin of Example 1, and the results are listed in Table 2.

### Comparative Example 7

A polyolefin microporous membrane was manufactured in the same manner as in Example 1, except that the film from which a paraffin oil had been extracted was dried to be shrunk by 7% in the machine direction and 14% in the transverse direction as compared with the film before extraction, and the results are listed in Table 2.

### Comparative Example 8

A polyolefin microporous membrane was manufactured in the same manner as in Example 1, except that the film from which a paraffin oil had been extracted was dried to be stretched by 5% in the machine direction and 8% in the transverse direction as compared with the film before extraction and the heat fixation temperature was 136° C., and the results are listed in Table 2.

### Comparative Example 9

A polyolefin microporous membrane was manufactured in the same manner as in Example 1, except that the heat fixation temperature was 145° C., and the results are listed in Table 2.

TABLE 1

| | | Puncture | Gas | | Average | Shutdown | Meltdown |
|---|---|---|---|---|---|---|---|
| | Thickness | strength | permeability | Porosity | pore size | temperature | temperature |
| | (μm) | (N/μm) | (×10⁻⁵ Darcy) | (%) | (nm) | (° C.) | (° C.) |
| Example | 10.5 | 0.32 | 1.4 | 40.6 | 28.3 | 148.3 | >180 |
| 1 | | | | | | | |
| Example | 10.2 | 0.31 | 1.4 | 40.1 | 27.9 | 147.9 | >180 |
| 2 | | | | | | | |
| Example | 10.3 | 0.31 | 1.3 | 37.3 | 26.1 | 147.2 | >180 |
| 3 | | | | | | | |
| Example | 11.1 | 0.32 | 1.38 | 40.5 | 28.2 | 148.4 | >180 |
| 4 | | | | | | | |
| Example | 11.4 | 0.38 | 1.23 | 40.1 | 24.8 | 149.5 | >180 |
| 5 | | | | | | | |
| Example | 10.2 | 0.34 | 1.21 | 38.1 | 26.3 | 148.7 | >180 |
| 6 | | | | | | | |
| Example | 10.0 | 0.36 | 1.17 | 38.2 | 25.4 | 148.5 | >180 |
| 7 | | | | | | | |
| Example | 9.8 | 0.32 | 1.3 | 37.2 | 27.1 | 148.3 | >180 |
| 8 | | | | | | | |
| Example | 10.9 | 0.32 | 1.51 | 42.0 | 28.0 | 148.5 | >180 |
| 9 | | | | | | | |

TABLE 2

| | | Puncture | Gas | | Average | Shutdown | Meltdown |
|---|---|---|---|---|---|---|---|
| | Thickness | strength | permeability | Porosity | pore size | temperature | temperature |
| | (μm) | (N/μm) | (×10⁻⁵ Darcy) | (%) | (nm) | (° C.) | (° C.) |
| Comp. | 11.8 | 0.29 | 1.5 | 41.1 | 29.5 | 158.4 | >180 |
| Example | | | | | | | |
| 1 | | | | | | | |
| Comp. | 11.5 | 0.29 | 1.4 | 40.8 | 29.8 | 155.9 | >180 |
| Example | | | | | | | |
| 2 | | | | | | | |
| Comp. | 9.6 | 0.17 | 0.8 | 31.1 | 24.8 | 144.4 | >180 |
| Example | | | | | | | |
| 3 | | | | | | | |
| Comp. | 9.5 | 0.37 | 0.8 | 32.7 | 34.9 | 152.7 | >180 |
| Example | | | | | | | |
| 4 | | | | | | | |
| Comp. | 9.0 | 0.35 | 0.7 | 30.3 | 24.1 | 148.5 | >180 |
| Example | | | | | | | |
| 5 | | | | | | | |
| Comp. | 10.4 | 0.32 | 1.37 | 40.4 | 28.2 | 148.7 | 174 |
| Example | | | | | | | |
| 6 | | | | | | | |
| Comp. | 8.4 | 0.39 | 0.4 | 26.3 | 22.4 | 149.3 | >180 |
| Example | | | | | | | |
| 7 | | | | | | | |
| Comp. | 12.8 | 0.25 | 2.1 | 35.4 | 42.5 | 151.8 | >180 |
| Example | | | | | | | |
| 8 | | | | | | | |
| Comp. | | | | | | | |
| Example | 8.8 | 0.43 | 0.5 | 28.8 | 23.7 | 148.5 | >180 |
| 9 | | | | | | | |

Referring to Table 1, it was found that the microporous membranes of Examples 1 to 9 had the puncture strength, the gas permeability, the porosity, and the average pore size which allow battery performance to be secured, and also had the shutdown temperature and the meltdown temperature which allow battery thermal safety to be secured.

However, the microporous membranes of Comparative Examples 1 and 2 had the shutdown temperature of 158.4° C. and 155.9° C., as a result of using more than 80 wt % of the polypropylene resin. Accordingly, the batteries to which Comparative Examples 1 and 2 were applied had closed pores and greatly deteriorated thermal safety.

The microporous membrane of Comparative Example 3 used less than 60 wt % of the polypropylene resin, and as a result, did not satisfy the ranges of the puncture strength and the gas permeability specified according to the present disclosure. Accordingly, the battery to which Comparative Example 3 was applied did not function effectively as a battery

The microporous membrane of Comparative Example 4 used the polyethylene resin having a weight average molecular weight of more than 1.0×10⁶ g/mol, and as a result, it did not meet the specified ranges for gas permeability and shutdown temperature according to the present disclosure. Accordingly, the battery to which Comparative Example 4 was applied did not function effectively as a battery and had greatly deteriorated thermal safety.

The microporous membrane of Comparative Example 5 used the polyethylene resin having the melting temperature of lower than 133° C., and as a result, did not satisfy the range of the gas permeability specified according to the present disclosure. Accordingly, the battery to which Comparative Example 5 was applied did not function effectively as a battery.

The microporous membrane of Comparative Example 6 used the polypropylene resin having the melting temperature of lower than 160° C., and as a result, did not satisfy the range of the meltdown temperature specified according to the present disclosure. Accordingly, in the battery to which Comparative Example 6 was applied, a positive electrode and a negative electrode were internally short-circuited due to the rupture of the separator greatly deteriorating thermal safety.

The microporous membrane of Comparative Example 7 was subjected to an extraction/drying process at a longitudinal shrinkage of more than 5% and a transverse shrinkage of more than 10%, and as a result, did not satisfy the ranges of the gas permeability and the porosity specified according to the present disclosure. Accordingly, the battery to which Comparative Example 7 was applied did not function effectively as a battery.

The microporous membrane of Comparative Example 8 was subjected to an extraction/drying process by stretching without longitudinal shrinkage by 5% or less, and as a result, did not satisfy the ranges of the average pore size and the shutdown temperature specified according to the present disclosure. Accordingly, the battery to which Comparative Example 8 was applied did not function effectively as a battery and had greatly deteriorated thermal safety.

The microporous membrane of Comparative Example 9 was subjected to a heat fixation process at a temperature higher by 11° C. than the melting temperature of the polyethylene resin, and as a result, did not satisfy the ranges of the gas permeability and the porosity specified according to the present disclosure. Accordingly, the battery to which Comparative Example 9 was applied did not function effectively as a battery.

The polyolefin microporous membrane according to the present disclosure secures significantly improved heat resistance at a high temperature.

In addition, the polyolefin microporous membrane according to the present disclosure has closed pores at a low temperature and maintains a separator form at a high temperature.

In addition, the polyolefin microporous membrane according to the present disclosure exhibits a shutdown temperature of 150° C. or lower and a meltdown temperature of 180° C. or higher.

In addition, the polyolefin microporous membrane according to the present disclosure exhibits excellent mechanical strength and gas permeability.

In addition, the inventive battery has excellent thermal safety at a high temperature by including the polyolefin microporous membrane according to an embodiment.

The above description provides embodiments to which the technical concepts of the present disclosure are applied. Many other embodiments, and variations thereof may be further implemented by those with ordinary skill in the art without departing from the scope of the present disclosure as defined in the appended claims. Furthermore, the embodiments may be combined to form additional embodiments.

What is claimed is:

1. A polyolefin microporous membrane comprising: 60 wt % to 80 wt % of a polypropylene having a viscosity average molecular weight of 1×10⁶ g/mol to 3×10⁶ g/mol and 20 wt % to 40 wt % of a polyethylene having a weight average molecular weight of 1×10⁵ g/mol to 10×10⁵ g/mol,
wherein the polyolefin microporous membrane has a puncture strength of 0.25 N/μm or more, a gas permeability of 1.0×10⁻⁵ Darcy or more, a porosity of 30% to 70%, an average pore size of 20 nm to 40 nm, a shutdown temperature of 150° C. or lower, and a meltdown temperature of 180° C. or higher.

2. The polyolefin microporous membrane of claim 1, wherein the polypropylene has a melting temperature of 160° C. or higher.

3. The polyolefin microporous membrane of claim 1, wherein the polyethylene has a melting temperature of 133° C. or higher.

4. The polyolefin microporous membrane of claim 1, wherein the microporous membrane has a thickness of 3 μm to 30 μm.

5. The polyolefin microporous membrane of claim 1, wherein the shutdown temperature is 149° C. or lower.

6. The polyolefin microporous membrane of claim 1, wherein the polyolefin microporous membrane is manufactured by a wet method including a sequential biaxial stretching process.

7. A method for manufacturing a polyolefin microporous membrane, the method comprising:
(a) melt kneading a mixture including a polyolefin resin and a diluent through an extruder to prepare a molten material;
(b) extruding the molten material to be molded into a sheet form;
(c) sequentially biaxially stretching the sheet in machine and transverse directions to be molded into a film;
(d) extracting the diluent from the stretched film and drying the film; and
(e) heat treating the dried film,
wherein the polyolefin resin of (a) includes 60 wt % to 80 wt % of a polypropylene having a viscosity average molecular weight of 1×10⁶ g/mol to 3×10⁶ g/mol and 20 wt % to 40 wt % of a polyethylene having a weight average molecular weight of 1×10⁵ g/mol to 10×10⁵ g/mol.

8. The method for manufacturing a polyolefin microporous membrane of claim 7, wherein extracting the diluent from the stretched film includes extracting the diluent from the stretched film and drying the film with shrinkages of 5% or less in the machine direction and 10% or less in the transverse direction.

9. The method for manufacturing a polyolefin microporous membrane of claim 7, wherein heat treating (e) is heat treating the dried film in a temperature range between a melting temperature of the polyethylene (Tm) and a temperature higher than the melting temperature by 8° C. (Tm+8° C.).

10. A separator comprising the polyolefin microporous membrane of claim 1.

11. A lithium secondary battery employing a separator disposed between an anode electrode and a cathode electrode, the separator comprising a polyolefin microporous membrane comprising: 60 wt % to 80 wt % of a polypropylene having a viscosity average molecular weight of 1×10⁶ g/mol to 3×10⁶ g/mol and 20 wt % to 40 wt % of a polyethylene having a weight average molecular weight of 1×10⁵ g/mol to 10×10⁵ g/mol.
